(19) United States
(12) Patent Application Publication
(10) Pub. No.: US 2003/0014280 A1
(43) Pub. Date: Jan. 16, 2003

(54) Healthcare claims data analysis

(75) Inventors: Euguenia Jilinskaia, Chestnut Hill, MA (US); Stanley Norton, West Newbury, MA (US); Trung Do, Brookline, MA (US)

Correspondence Address: HALE AND DORR, LLP, 60 STATE STREET, BOSTON, MA, 02109

(73) Assignee: PharMetrics, Inc.

(21) Appl. No.: 10/084,239

(22) Filed: Feb. 27, 2002

Related U.S. Application Data
(60) Provisional application No. 60/272,561, filed on Mar. 1, 2001.

(51) Int. Cl. G06F 17/60

(52) U.S. Cl. 705/2

(57) ABSTRACT

A method for analyzing healthcare claims data determines values for missing data for analysis purposes.

### CROSS REFERENCE TO RELATED APPLICATION

This application claims priority from provisional serial No. 60/272,561, filed Mar. 1, 2001, which is incorporated herein by reference.

### BACKGROUND OF THE INVENTION

A database of healthcare claims data for analysis may contain data from a number of different health plans. Such claims are made from medical practitioners to insurance carriers for payment. Efforts have been made to standardize such data, and every data set undergoes a rigorous data quality validation process.

Two important data elements in the analysis of healthcare expenditures are ‘Charged’ (or ‘Claimed’ or ‘Charge’) and ‘Paid’ amounts. “Charged” refers to what a doctor or other practitioner charges the insurance carrier for a service provided; “Paid” is what the practitioner is actually paid by the carrier for the service. Historically, a significant number of submitted claims data have not included Paid amounts (observed in 5-15% of the claims in a representative data set). As a result, in past analyses, studies involving costs have relied upon the Charged amount rather than Paid.

In many respects, the use the of Charged amount is less than optimal. Many pharmaceutical companies and healthcare organizations analyze cost based upon actual expenditures rather than an arbitrary Charged amount.

Paid amounts have typically not been provided in healthcare claims for a number of reasons, including: (1) in capitated reimbursement models, providers receive reimbursement on a per member per month (pmpm) basis, and there is no need to provide payment information for each procedure; (2) there are specific contractual arrangements between the provider and healthcare organization, and such arrangements may vary widely from one organization to the next; and (3) within an organization arrangements may vary based on product offering or geographical location. Additionally, managed care medical and pharmaceutical claims are inherently problematic due to the variety of billing systems and processes employed.

### SUMMARY OF THE INVENTION

A system and method according to an embodiment of the present invention populate data sets with imputed charged and paid amounts. This system and method allow for more comprehensive and applicable analyses of healthcare expenditures.

In a preferred embodiment, two new fields are added to the production database, called ‘pmcharge’ and ‘pmpaid’. If the charged or paid fields in a data set have invalid data (e.g., a value less than or equal to zero), the amount is imputed and entered into the appropriate pm field. On the other hand, if the submitted data have valid charged or paid values, those amounts are used.

This method can be used to impute a paid amount in the absence of valid paid data, but in presence of valid charged data, or vice versa. The imputation method includes determining a quotient to apply to the valid value (charged or paid). The quotient is specific to each data set as well as to each ETG record type (Management, Ancillary, Pharmacy, Facility, and Surgery). This method ensures a high degree of validity.

Healthcare claims data can be more accurately and completely analyzed with the values included. Other features will become apparent from the following detailed description and claims.

### DETAILED DESCRIPTION

In an embodiment of the present invention, a system processes healthcare claims data according to a method that includes the following processes:

a) In each data source, estimate the percentage of (1) missing Paid values, (2) Paid values with 0, and (3) Paid values less than 0. If these Paid values are less than 30%, the data set continues to be processed. If the Paid values are more than 30%, the data set is combined with other similar data sets (from the same region) and processing continues.

b) Create a “learning sub-sample”, where only those observations with non-zero values of Paid and Charge>=Paid are included.

c) Estimate a coefficient of correlation for each data source. Check if the coefficient is less than 0.6. If the coefficient is less than 0.6, investigate for possible contamination or extreme outliers.

d) Estimate the slope of a regression line with an intercept forced through zero. Check the quality of fit (is the value of R² less than 0.5?).

e) Create a variable, Rate=Paid/Charge, where values are more than 0 but less than 1 on the “learning sub-sample”. If records contain values of <=00 0, ignore as estimation cannot be performed.

f) Estimate mean and median values for distribution of the Rate-variable for each data source and each type of claim separately and for the combined sample (the whole abstract).

g) Estimate the slope of the regression line, e.g., using Iteratively Re-weighted Least Squares (IRLS) estimates with the median value of Rate as the initial value.

h) Create a variable “pmpaid” (estimated Paid amount) using the estimated median Rate (from step e), multiplied by Charge (separately by each data source and each type of claim) for non-negative values of Charge.

pmpaid=Charge*Median (Paid/Charge)

The same methodology can be implemented in the reverse order in the event there are valid values of the Paid variable, corresponding to zero or negative values of Charge variable. The advantage of using the median of Rate is that in this case, one can estimate the unknown value of Charge using the same “learning sub-sample” and the same coefficient Median (Paid/Charge), creating new variable,

pmcharge=Paid/Median (Paid/Charge).

Rules for Estimating Charge and Paid

If Charge>=Paid>0, then

pmpaid=Paid, pmcharge=Charge

If Charge and Paid are both invalid (0 or less), then

pmpaid=0 and pmcharge=0

If Paid<=0 and Charge>0, then

pmpaid=Charge*Median (Paid/Charge),

pmcharge=Charge

If Paid>0 and Charge<=0, then

pmpaid=Paid,

pmcharge=Paid/Median (Paid/Charge)

If Paid>0 and Charge>0, but Paid>Charge, then

pmpaid=Paid,

pmcharge=Paid/Median (Paid/Charge).

Preliminary Statistical Analysis of Data

Preliminary statistical analysis of data detected a significant difference between the empirical distribution and normal distribution for the random variables, Charge and Paid. This difference can be explained by several factors: (1) only values greater than zero are analyzed; (2) there are a high number of outliers; and (3) the data is largely skewed and non-homogenous. The consequence is that the use of methods based on an assumption of normal distribution can lead to biased or inconsistent results.

The hypothesis of Charge>=Paid was confirmed using Sign-Test, which showed that a one-sided test comparing the variables was significantly larger than zero.

Non-homogeneity of the sample was confirmed by results of the General Linear Models procedure, with Duncan multiple range test comparing mean values of variables Charge and Paid, classified by categorical variable Rectype (type of service claim records).

As means with the same grouping letter are not significantly different, the data demonstrates the variability based on record type.

It was believed that there was a strong correlation between the Charge and Paid variables. Preliminary statistical analysis on 21 different data sources showed significantly high correlation coefficients.

Ratio Estimate

A ratio estimate approach is based on the distribution of ratio for two random variables, Paid and Charge. This ratio (Rate) is also a random variable with values from 0 to 1. Result of an SAS output based on one data source and a chart of Rates at 0.05 intervals versus numbers of records are provided in the incorporated provisional application.

To estimate an unknown parameter K for predicting Paid as (K) (Charge), the sample mean value of the variable can be used, where Rate=Paid/Charge or a more robust method such as sample median. Because of the prevalence of extreme outliers the latter was employed.

Iteratively Re-Weighted Least Squares (IRLS)

Classical methods of regression analysis may not be valid when data does not follow normal distribution, has significant outliers, or is relatively small in size. In the case when errors in predictors are large, the use of ordinary least squares estimates can lead to bias and, sometimes, inconsistent estimates of unknown parameters. Least squares estimates are only optimal in the case of normal distribution. For example, for exponential distribution, the best estimates are derived from the method of minimization of the sum of absolute values of residuals. In this case, it is more promising to implement so-called “robust estimates,” which use methods that are not sensitive to changes to the assumptions, on the type of distribution, or existence of contamination and outliers in the distribution.

Several different methods of robust estimation were considered other than IRLS. Robust estimates for parameter of location can be used instead of ordinary sample mean, which is an efficient estimate of normally distributed random variables. Median, vinsorized mean, and α-trimmed mean are examples of the most frequently used robust estimates.

Robust estimates for parameter of regression can be used instead of ordinary estimates (minimizing sum of squares of residuals from the regression line), estimates of least sum of absolute values of residuals, M-estimates (proposed by Huber replaces the squared residuals by another function), and estimates of least median of squares (LMS) of residuals.

Another property of LMS estimates is that it is equivariant with respect to linear transformations on the explanatory variables, because LMS uses residuals. The main disadvantage of LMS estimates is their slow convergence Rate. LMS estimates tend to perform poorly from the point of view of asymptotic efficiency (bad performance on small sample sizes). So for acceptable results using this method, large sample sizes are necessary. To improve this situation, LTS-estimates (least trimmed squares) were proposed. Compared to ordinary least squares, the only difference is that the largest squared residuals are not used in the summation, thereby minimizing the effect of large outliers on the best-fit line.

IRLS estimates are weighted least squares using the residuals (how far outlying the observations are) as weights. The weights dampen the effect of outliers and are revised with each iteration until a robust fit is obtained. Different weight functions refer to different IRLS procedures, where the choice of proper weight functions can be done more correctly, if a priori information regarding the parametric type of distribution exists.

While the robust regression method was slightly more accurate than ratio estimate in most cases, but it can be resource intensive in terms of processing time. The similar results of the ratio estimate and robust regression method provide confidence that ratio estimates is statistically sound. Also, because ratio estimates were far simpler to perform and faster in terms of processing time, it was chosen as more preferable for imputing unknown Charge or Paid values.

Variability by Record Type

The coefficient varies not only from one data set to another, but also by type of record. Record type are denoted as F—Facility, P—Pharmacy, A—Ancillary, S—Surgery, M—Management. Exact values of the slopes for different data sets and different types of records are shown in the table and chart in the incorporated provisional application.

The most consistent slope between the data sets is in Pharmacy claims, but the wide variance amongst the data sets by record type supports the assumption that imputation should be performed by record type.

The methods of the present invention can be implemented with a conventional computer or group of computers operatively connected to a storage system, such as a conventional database. The data that is determined according to the methods are useful to provide to the pharmaceutical industry data relating to actual costs of procedures.

Having described an embodiment, it should be apparent that modifications can be made without departing from the scope of the invention as defined by the appended claims.

1. A method for analyzing healthcare claims data with records in which the claims data can include entries for a service that was charged and what was paid for the service, wherein some of the claims data does not indicate either the amount charged or the amount paid, the method including analyzing the claims data and imputing charged or paid amounts where such amounts were not indicated, and using the imputed amounts for analysis.

2. The method of claim 1, wherein the imputing includes determining a ratio of the paid to charged values.

3. The method of claim 2, wherein the ratio is determined for records that have non-zero values for both paid and charged amounts such that the charged amount is greater than or equal to the paid amount.

4. The method of claim 3, further including estimating median values for distribution of the ratio variable for each data source and each type of claim separately and for the combined sample.

5. The method of claim 4, further comprising estimating the slope of the regression line with the median value of the ratio as the initial value.

6. The method of claim 3, wherein the ratio is separately determined for different types of records, including one or more of facility, pharmacy, surgery, management, or ancillary.

7. The method of claim 1, wherein the paid values are imputed.

8. The method of claim 1, wherein the charged values are imputed.

9. A system for analyzing healthcare claims data with records in which the claims data can include entries for a service that was charged and what was paid for the service, wherein some of the claims data does not indicate either the amount charged or the amount paid, the system comprising a database for storing claims data records, and a processor for analyzing the claims data and imputing charged or paid amounts where such amounts were not indicated, and using the imputed amounts for analysis.

10. The system of claim 9, wherein the processor determines a ratio of the paid to charged values.

11. The system of claim 10, wherein the processor determines a ratio for records that have non-zero values for both paid and charged amounts such that the charged amount is greater than or equal to the paid amount.

12. The system of claim 11, wherein the processor estimates median values for distribution of the ratio variable for each data source and each type of claim separately and for the combined sample.

13. The system of claim 12, wherein the processor estimates the slope of the regression line with the median value of the ratio as the initial value.

14. The system of claim 11, wherein the processor separately determines the ratio for different types of records, including one or more of facility, pharmacy, surgery, management, or ancillary.

15. The system of claim 9, wherein the paid values are imputed.

16. The system of claim 9, wherein the charged values are imputed.
